(19) United States
(12) Patent Application Publication
(10) Pub. No.: US 2006/0230541 A1
(43) Pub. Date: Oct. 19, 2006

(54) Dye removal from denim scrap with a forced circulation kier

(76) Inventors: Gary F. Hirsch, Woodside, CA (US); Robert T. Patton, Lake Jackson, TX (US); David M. Hall, Auburn, AL (US)

Correspondence Address: DOERNER, SAUNDERS, DANIEL & ANDERSON, 320 SOUTH BOSTON, SUITE 500, TULSA, OK, 74103, US

(21) Appl. No.: 10/491,015

(22) PCT Filed: Sep. 25, 2002
(86) PCT No.: PCT/US02/30561

§ 371 Date: Sep. 27, 2005

(30) Foreign Application Priority Data
Sep. 26, 2001 (US) 09963846

(51) Int. Cl. C11D 3/00

(52) U.S. Cl. 8/115.51

(57) ABSTRACT

A recyling process for liquid treatment of denim scrap comprising placing denim scrap on a support surface (50) to form a thickness of flat, layered denim scrap (7). To the top surface is applied a compression plat (56) to form the thickness of denim scrap into a compact cake (54). Then treatment liquid is passed through the interior of the compact cake (54) in a direction parallel to the surfaces of the scrap, the liquid passing between opposed surfaces of the denim pieces. The treatment liquid can be a solvent for oxidized indigo dye; an aqueous solution containing a desizing agent; an aquueous solution containing a reducing agent for indigo dye; a solution containing desizing and reducing agent; an aqueous solution containing a reducing agent for indigo dye; or a sequences of these liquids.

### FIELD OF THE INVENTION

This invention relates to a process for removing indigo dye from denim scrap with a forced circulation kier. In particular, the process of this invention is directed to a method for removing indigo dyes from scrap textiles such as denim scrap where the vat dyes have been applied while in a reduced, soluble form and oxidized to precipitate the dye in and on the fabric in an insoluble form.

### BACKGROUND OF THE INVENTION

Cotton and other cellulose scraps produced when cutting cotton fabrics in clothing manufacture are a waste product typically buried in landfills or consumed in incinerators. Garnetting to separate and recover the cotton fibers shortens the fiber length and the products had few uses. As a consequence, over 200 million pounds of denim scrap, in the U.S. alone, is destroyed as waste each year.

U.S. Pat. Nos. 5,376,143 and 5,471,720 describe a process for recycling denim waste by separating the fibers, preparing a colored yarn of a blend of the recycled fibers and virgin fibers, and preparing denim or similarly dyed fabric from the yarn. This process has not been commercially implemented, perhaps because of costs of fiber separation and the limitations of the shortened fibers in the making a strong, durable fabric.

Many applications of cotton, however, do not require long fibers. Cotton batting is a popular absorbent because of its softness and cushioning characteristics and high water absorbency. It is a preferred component for many industrial, household and particular medical products such as quilts, upholstery, sanitary napkins, diapers and medical products such as swabs, bandages and the like. However, most of these applications require the cotton fibers be colorless and strong, and a process for recycling cotton scrap to produce cotton fibers for these applications has not been commercially feasible because of the difficulties in processing the scrap. One principal area of difficulty is removal and/or decolorizing the vat dyes present in many cotton scraps such as denim.

Vat dyes consist of colored compounds which are usefully precipitated within cellulosic fibers. These compounds are reversibly changed to a water-soluble “leuco” state by chemically reducing them. This is done easily by mixing the dye into a water solution containing a water-soluble reducing agent such as sodium hydrosulfite and an alkali such as sodium hydroxide. In a dying process, the cellulosic fiber is typically immersed in such a reduced, leuco solution, and the dye is allowed to penetrate the substrate. After this immersion, the fiber is exposed to an oxidizing environment. Such an environment is air and in one such process, the yarn, wetted in a leuco solution is draped in long beams over rolls and exposed to air until the dye and accompanying reducing agents are oxidized. Dilute hydrogen peroxide is also used for this oxidation. In each case, the oxidizing medium converts the leuco dye to its original water-insoluble state. If the dye molecule is contained within the cellulose substrate, the water-insoluble dye is trapped and cannot be removed by casual exposure to water and detergents.

Fabric is often dyed with more than one leuco form of dye. It is a common practice to dye dark shades of indigo first with the leuco form of black sulfur dye and second with the leuco form of blue indigo dye. Both dyes require subsequent oxidation to render them water-insoluble.

U.S. Pat. No. 5,366,510 describes a process for desizing and color fading indigo dyed garments by contacting them with a reducing agent in an aqueous solution to extract dye materials before the fabrics are bleached to produce the faded, “stone washed” or “acid washed” appearance popular with denim materials. The dye is removed in a conventional rotary drum washer-extractor. Treatment of denim scrap by this procedure tends to produce tightly rolled up scrap pieces from which all of the dye is not extracted or to unravel the scraps, producing useless balls and tangles of yarn and fabric scraps or individual yarn pieces which foul the bath or equipment components.

For the economical recovery of useful products from textile scraps such as denim scraps, dye removal and recovery is highly desirable. The value of the recovered dye partially offsets the costs of the recycling. Also, the recovery removes an undesirable component from the waste water.

Solvent removal of dyes from synthetic fabrics is a known procedure. U.S. Pat. No. 1,839,819 describes a method for removing dyes from synthetic textiles using heated organic solvents selected to swell the cellulose acetate and cellulose ether fibers and remove solvent soluble dyes without any chemical change of the dyes, thus preserving them for reuse.

However, an effective solvent extraction system for textile scraps like denim scraps has not been feasible. The solvent removes size, softness, surfactants, finishes and fully oxidized dye from the fabric, producing a solution of these components. Solvent evaporation yields a cake or solution of these components which is useless without a further, expensive purification process.

In U.S. Pat. No. 5,989,296 a process is described for removing indigo dye from denim scrap by extracting the fabric with an organic solvent in which the indigo dye is soluble at elevated temperatures, the solvent is cooled and extracted with an aqueous phase containing a reducing agent, and the aqueous phase is treated to oxidize and recover the indigo dye.

U.S. Pat. No. 5,366,510 describes a process for desizing and color fading indigo dyed garments by contacting them with a reducing agent in an aqueous solution to extract dye materials before the fabrics are bleached to produce the faded, “stone washed” or “acid washed” appearance popular with denim materials. The dye is removed in a conventional rotary drum washer-extractor. Treatment of small denim scrap in this procedure tends to unravel the scraps, producing useless balls and tangles of yarn and fabric scraps which foul the washer-extractor.

### OBJECTS AND SUMMARY OF THE INVENTION

One object of this invention is a highly effective process for treating denim scrap with extraction solvents for extracting the majority of dye from denim to yield a scrap lightly tinted with indigo dye residue.

Another object of this invention is a highly effective process for treating denim scrap with a catalyzed hydrogen peroxide bleaching process to remove the remaining color in the fabric.

A third object of this invention is the use of a uniquely suitable forced circulation kier to achieve the above objects.

In summary, the fabric scrap recycling process of this invention comprises the steps of (a) placing sufficient denim scrap pieces on a support surface to form a thickness of flat, layered denim scrap comprising individual denim pieces with opposed surfaces having approximately parallel orientations, the thickness having a top surface; (b) applying a compression plate to said top surface to form the thickness of denim scrap into a compact cake; and (c) passing liquid through the interior of the compact cake in a direction parallel to the surfaces of the scrap, the liquid passing between opposed surfaces of the denim pieces.

The denim scrap pieces preferably have a widest width of less than 4 inches and optimally have a widest width of less than 2 inches and an average widest width of greater than one inch.

In one embodiment, the liquid is a solvent for indigo dye, whereby indigo dye is removed from the denim scrap by said liquid.

In another embodiment, the liquid is an aqueous solution containing a desizing agent, whereby size is removed from the denim scrap pieces.

In a still further embodiment, the liquid is an aqueous solution containing a reducing agent for indigo dye, whereby dye in the denim pieces is reduced to a soluble, reduced leuco form, dissolves in the solution, and size and dye are both removed from the denim scrap pieces simultaneously.

In another embodiment, the liquid is an aqueous solution containing a reducing agent for indigo dye, whereby dye in the denim pieces is reduced to a soluble, reduced form, dissolves in the solution, and is removed from the denim scrap pieces for later recovery.

In a still further embodiment, the liquid is an aqueous solution containing a catalyzed hydrogen peroxide solution, the catalyst being a catalyzing amount of a transition metal cation or quaternaryalkylamine salt which catalyzes oxidation reactions of hydrogen peroxide, whereby any residual indigo dye in the denim scrap pieces is bleached to remove color therefrom.

In still a further embodiment, the liquid will contain dyes, chemicals and reagents that may assist in enabling optimization of the fabrics of this invention for utilization in subsequent processes or end use applications. Thus, the liquid may contain humectants, antibacterial agents, lubricants, dyes or tints, optical brighteners, hand modifiers, antistatic agents and the like.

In a still further embodiment, the liquid is an aqueous solution containing an alkali metal hypochlorite whereby any residual indigo dye in the denim scrap pieces is bleached to remove color therefrom.

A combined processing embodiment of this invention liquid treatment of denim scrap to remove dye from the scrap and decolorize the scrap comprises the steps of (a) placing sufficient denim scrap pieces on a support surface to form a thickness of flat, layered denim scrap comprising individual denim pieces with opposed surfaces, the thickness having a top surface; (b) applying a compression plate to said top surface to form the thickness of denim scrap into a compact cake; (c) passing a first aqueous solution through the interior of the compact cake in a direction parallel to the surfaces of the scrap, the first aqueous solution passing between opposed surfaces of the denim pieces, the first aqueous solution containing a reducing agent whereby sizing is removed and dye in the denim pieces is reduced to a soluble, reduced form, dissolves in the solution, and is removed from the denim scrap pieces; and (d) passing a second aqueous solution through the interior of the compact cake in a direction parallel to the surfaces of the scrap, the second aqueous solution passing between opposed surfaces of the denim pieces, the second aqueous solution containing a catalyzed hydrogen peroxide solution, the catalyst being a catalyzing amount of a transition metal cation or quatemary alkylamine salt which catalyzes oxidation reactions of hydrogen peroxide, whereby residual indigo dye in the denim scrap pieces is bleached to remove color therefrom. Alternatively step (d) may be accomplished by passing a solution of alkali metal hypochlorite through the interior of the compact cake whereby residual indigo dye in the denim scrap pieces is bleached to remove color therefrom. A further aqueous solution or combination solution can be used to add various dyes, chemicals and reagents that may assist in optimization of the fabrics of this invention in subsequent processes or end use applications.

### BRIEF DESCRIPTION OF THE DRAWINGS

FIG. 1 is a schematic cross-sectional view showing the structure of the treatment section of the vessel according to an aspect of this invention.

FIG. 2 is a schematic view of layered denim scraps in the fabric containment basket shown in FIG. 1 showing the flow of liquid treating liquids between the fabric layers to achieve uniform exposure of the fabric surfaces by the treating liquids according to an aspect of this invention.

FIG. 3 is a cross-sectional representation of a forced circulation kier fabric containment basket according to an aspect of this invention.

### DETAILED DESCRIPTION OF THE INVENTION

The process of this invention is described hereinafter in terms of extracting dye from denim scrap and bleaching denim scrap because it is more demanding and requires description of more details than extracting and bleaching of dyed unfinished and finished cellulose fiber products such as clothing. Dye removal and bleaching of denim garments is desired to produce products having a faded “stone-washed” appearance, for example. It will be readily understood to a person skilled in the art that the process of this invention can be applied to remove all or only a portion of the color in a dyed fabric or garment of cellulose or other material and all of these bleaching applications are intended to be included within the scope of this invention.

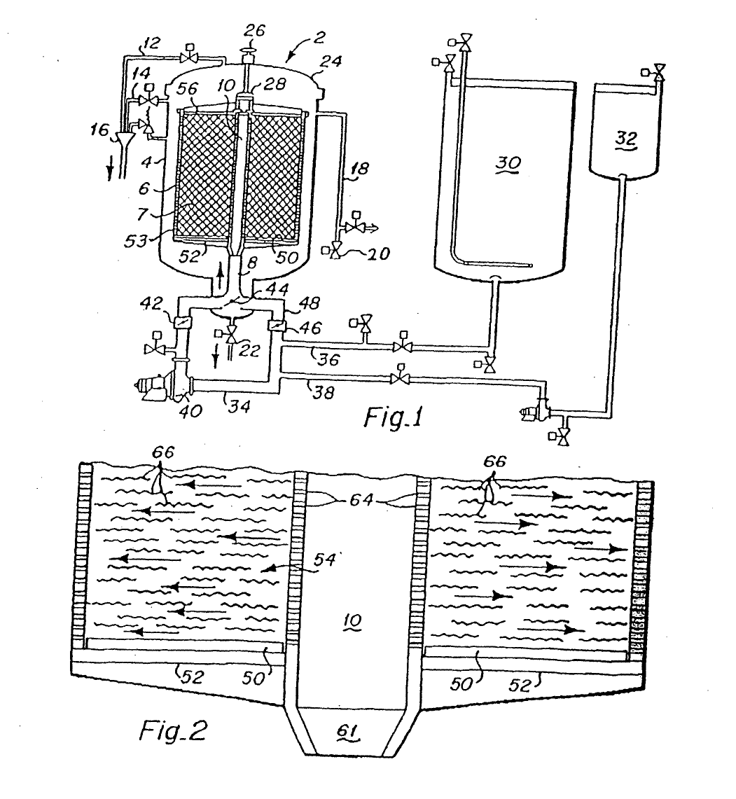

FIG. 1 is a cross-section representation of a forced circulation kier suitable for use in the processes of this invention. FIG. 2 is a schematic cross-sectional view showing the structure of the treatment section of the vessel shown in FIG. I showing the flow of liquid treating liquids between the laminae to achieve uniform exposure of the fabric surfaces by the treating liquids. The kier 2 comprises a closed vessel 4 housing the fabric containment basket 6. Treatment liquid is introduced into the bottom of the treatment section of the fabric containment basket 6 through pipe 8, and passes upward through the perforated distributor 10. Treatment liquid passes through the fabric bed 7, in fabric containment basket 6 and returns to the pump suction through diverter valve 44 and pump suction conduits 48 and 34. Alternatively, at appropriate intervals, the diverter valve 44 may be repositioned to cause treatment liquid to pass from pump 40 through pump discharge conduit 42 into the bottom of vessel 4 through the perforated fabric containment basket 6, through the fabric bed 7, the perforated distributor pipe 10, pipes 8, 48, and 34 and thence back to the pump 40. The treatment vessel is equipped with valved outlet conduits 12 and 14 leading to the drain 16 and sampling line 18. Vessel drain line 22 is provided to remove liquid contents for processing or disposal.

The vessel has a conventional flanged top lid closure 24 (details not shown) sealed into place when the vessel is loaded with denim scrap. After closure, valve wheel 26 is turned to force the tapered end of the perforated distributor pipe to seal against the gasketed top of pipe 8.

Treatment liquids can be prepared in vessels 30 and 32. For processes using reagents which are to be mixed immediately prior to use, the individual reagent solutions are introduced into the supply conduit 34 through conduits 36 and 38 from the respective tanks 30 and 32 where they are mixed as they pass through the pump 40, valves 42 and 44 and into either conduit 8 or the bottom of containment vessel 4.

Valves 42 and 46 are closed to isolate the vessel from the pump 40 to allow pressurized air to be circulated through the fabric for the purpose of drying the fabric.

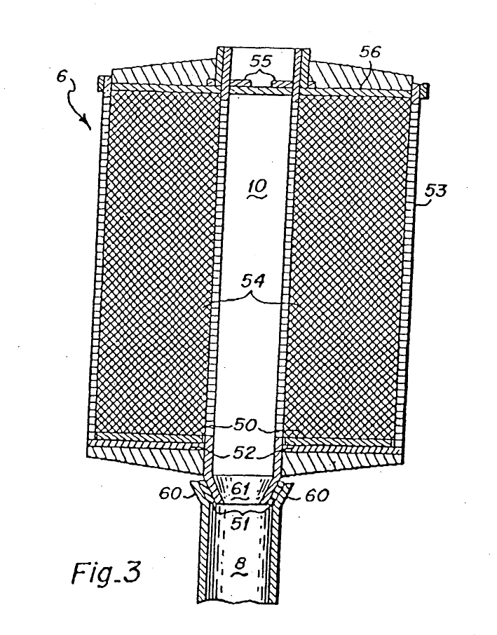

Referring to FIG. 3, the fabric containment basket comprises a bottom plate 50 supported by the liquid distributor plate 52 upon which the fabric scraps are deposited in a flat laminar orientation to form a fabric cake 54 (shown in FIG. 2). Referring also to FIG. 3, when the complete treatment load is deposited, top plate 56 is applied to the top of the fabric to compress it into a compact, homogeneous cake. Plate 56 is applied to a weighed charge of fabric 54 in the fabric containment basket 53 through the use of hydraulic press not shown. This creates the necessary fabric density to insure that liquid flow through the fabric cake is uniform and no channels develop which prevents some of the fabric from receiving adequate treatment. Plate 56 is held in place by a multiplicity of mechanically operated lugs 55, and in this manner, the fabric is maintained in a compressed state.

FIG. 2 is a schematic view of layered denim scraps in the fabric containment basket shown in FIG. 3, showing the flow of treating liquids between the fabric layers to achieve uniform exposure of the fabric surfaces by the treating liquids. Liquid passing through supply conduit 8 passes upward into the perforated distributor 10. The pressure of the liquid forces it outward through the perforations 64 and through the fabric layers, passing radially outward between opposed surfaces of the fabric pieces 66 and contacting all surfaces uniformly for extraction and/or oxidation of the dye in the fabric.

Referring to FIG. 1, the liquid passes outward through the fabric cake and into space between the fabric containment basket 6 and the wall of vessel 4 and returns through conduits 48 and 34 to pump 40. Alternatively, the diverter valve 44 may be repositioned so as to reverse the flow. In this case, the liquid passes inward through the perforated basket 6 through the fabric cake, through the perforated distributor 10, and back through conduits 48 and 34 to pump 40. In operation, it may be advantageous to reverse the direction of liquid flow repetitively so as to best contact all of the fabric scrap pieces with the treatment liquor.

Solvent Extraction of Dye

A process of removing dye from the fabric with solvent is described in U.S. Pat. No. 5,989,286, the contents of which are hereby incorporated by reference. As described therein, the process of this invention comprises the steps of scrap preparation, solvent extraction, solvent cooling, aqueous extraction and dye recovery.

Scrap typically has irregular shapes and sizes, and for uniform processing, cutting the fabric pieces having a uniform width of less than four inches and preferably about two inches is desirable. The scraps can be cut or chopped into these pieces using conventional fabric chopping equipment.

Because of the size and construction of the pieces of denim scrap, it is difficult to accomplish uniform processing in the bath processes for dye removal and bleaching. Denim is a twill fabric, hence is not a symmetrical weave. On the face side of the fabric, more warp yarn is exposed than fill yarn and on the other side, more fill yarn is exposed than warp yarn. In indigo dyed denim, the warp yarn is heavily dyed, and the fill yarn is undyed. Because of the asymmetry in construction and the different chemical history of the yarns, when denim scraps are wetted with solvent and agitated in a free state, they tend to curl and roll into spirals of fabric, sometimes tightly. A tightly wound spiral allows poor access in a circulating bath since inner portions are shielded by the outer layers. As a further problem, agitation tends to unravel the scraps, producing useless balls and tangles of yarn, yarn pieces and fibers which foul the bath components.

This problem is solved by use of a forced circulation kier in the process of this invention.

After the denim scrap is layered onto the bottom plate 50 and the top plate applied, extraction solvent is forced outward through the dense layers of fabric from the center distributor 10 or alternatively inward through the dense layers of fabric into the center distributor 10. The compressed layers maintain the scraps in a flat, laminated relationship, and the liquid passes under pressure from the center distributor radially outward between adjacent scrap surfaces, contacting all of the fabric surfaces and exposing the dyes in the fabric to the extraction solvent in a uniform treatment. The cake configuration prevents curling of the scrap, and maintains it in a flat, laminar orientation in the process cake.

Any organic solvent in which the dye is most soluble and which is not destructive to the fiber is suitable for use in the extraction. Preferred solvents are those with boiling points of less than 150° C. and which present the least environmental, safety, or toxilogical hazards.

The fabric dye dissolves in the solvent, is carried away from the fabric and passed to the drain, from which the solvent is collected for dye recovery and reuse.

Examples of operable solvents are:

Halogenated hydrocarbons
Perchloroethylene
ethane Tetrachlorodlfluoro
ethane

Alcohols
n-Butyl alcohol
n-Pentyl alcohol
Isopropyl alcohol
Isobutyl alcohol
Isopentyl alcohol

Ketones
Methyl isobutyl ketone
3-Hexanone
Methyl ethyl ketone
Methyl isobutyl ketone
Acetone

Carbonates
Diethyl carbonate
Dipropyl carbonate

Ethers
Ethoxybutane
Isoamyl vinyl ether
Butyl propyl ether
Isoamyl propyl ether
Butyl ether
Sec Butyl ether

Sulfones
Dimethyl sulfoxide
Diethyl sulfoxide
Dibutyl sulfoxide

Amides
Formamide
Dimethyl formamide
Chloral formamide

Esters
Isoamyl formate
Amyl formate

The scraps are contacted with the solvent at an elevated temperature below the ambient boiling point of the solvent. Preferably the extraction solvent is applied to the fabric at a temperature within the range of from 100° C. to 150° C.

Aqueous Dye Extraction Using a Reducing Agent

This process applies certain portions of the process of U.S. Pat. No. 5,366,510, the entire contents of which are hereby incorporated by reference.

After the denim scrap is layered onto the bottom plate 50 and the top plate applied, extraction solvent is forced outward through the dense layers of fabric from the center distributor 10 or alternatively, inward through the dense layers of fabric into the center distributor 10. The compressed layers maintain the scraps in a flat, laminated relationship, and the aqueous phase passes under pressure from the center distributor radially outward between adjacent scrap surfaces, contacting all of the fabric surfaces and exposing the dyes in the fabric to the extraction solvent in a uniform treatment. The cake configuration prevents curling of the scrap and maintains it in a flat, laminar orientation in the process cake.

Water from vessel 30 is mixed with an aqueous reducing agent from vessel 32 in the conduit 34 and pump 40 at an elevated temperature of about 120° C. to 180° C. Advantageously, a dye complexing agent such as polyvinyl pyrrolidone may be added to prevent redeposit of the degraded dye.

Suitable reducing agents which are useful for desizing starch type sizing and removing indigo and other vat dyes from denim scraps include alkali metal hydrosulfites, for example, sodium hydrosulfite; alkali metal sulfoxylate formaldehyde such as the sodium salt, thiourea dioxide, and the like.

Reducing agents which are primarily useful for removing the indigo and other vat dyes include alkali metal hydrogen sulfites, sulfides, thiosulfates, oxalates, hydrosulfites and hydrosulfides.

The most useful compounds are sodium hydrosulfite, sodium hydrosulfide and sodium sulfide.

Other suitable reducing agents include arsenous oxide and stannous sulfate.

Advantageously, sodium or zinc sulfoxylate formaldehyde is applied under either acid or basic conditions, and sodium hydrosulfite is used under basic conditions.

The amount of the reducing agent to be used is not critical, but stronger solutions are more efficient. A solution of from 1 to 50 grams per liter of sodium hydrosulfite or the equivalent is suitable.

The reducing agent converts the indigo and other vat dyes in the fabric to their water soluble leuco state, and the dye is carried into solution, removed from the fabric and passed to the drain from which it is captured for dye recovery.

Alkaline Hydrogen Peroxide Bleaching

After removal of the reducing solutions and rinsing with water, a catalyzed hydrogen peroxide bleaching solution is passed through the distributor 10 and outward between the scrap surfaces according to the process of this invention.

The hydrogen peroxide bleaching solution should have a concentration of hydrogen peroxide of from 0.2 to 3%. The preferred concentration range is preferably from 0.25 to 1.0%. The solution pH is preferably within the range of from 10.5 to 11.0, and the process water temperature is preferably within the range of from 95° C. to 130° C.

This invention is based on the discovery that with appropriate catalysts, hydrogen peroxide can effectively decolorize dyes which have been selected to be oxidation resistant, even dyes which are routinely insolubilized with hydrogen peroxide without loss of color. And even more surprisingly, very satisfactory decolorizing is obtained without significant loss of fiber strength or fiber quality.

Suitable catalysts include transition metal ions, preferably cupric and stannic ions. Other transition metal ions such as chromium, cobalt, and nickel also exhibit catalyst activity. The concentration of catalyst must be sufficient to catalyze the bleaching reaction but should be insufficient to cause spontaneous and rapid decomposition of the hydrogen peroxide. A catalyst concentration of from 0.1 to 2 ppm is usually operable and a concentration of from 0.3 to 0.7 ppm is preferred. Careful control of catalyst concentration is required.

Because these catalysts cause decomposition of the hydrogen peroxide at higher concentration, quantities of transitional metal ions normally present in conventional water can cause serious problems. It is necessary, therefore, to first remove all transition metal cations through the use of an ion exchange bed before addition of the carefully metered catalytic concentration of transition metal cations. Additionally, it is necessary to rinse the fabric bed with rinse water containing a chelate in order to deactivate any transition metal cations contained within the bed.

Chelates are coordination compounds having multidentate ligands, that is, ligands which bond to a metal atom at more than one place in a process termed chelation. Any water-soluble chelating agent effective to complex and deactivate the catalytic activity of transition metal ions can be used. One suitable water-soluble chelating agent is EDTA (ethylenediaminetetraacetic acid). Another suitable chelating agent is nitrilo triacetic acid.

Of course, the chelating agent can also complex and deactivate the desired metal catalysts, and the amount of chelating agent must be carefully titrated to complex all of the contaminants and avoid a significant surplus over the amount required for this purpose. Obviously, constant testing and titration the chelating agent requirements are necessary if the amounts of contaminants in the water are highly variable.

Water-soluble quaternary amines are preferred catalysts because they are not significantly complexed and deactivated by conventional chelating agents. Suitable water-soluble quaternary amines include (lower alkyl) ammonium halides and their derivatives such as hydroxy and epoxy substituted (lower alkyl) trimethylammonium halides such as substituted propyltrimethylammonium chloride, Preferred quaternary amines for use in the process of this invention are dihydroxypropyltrimethylammonium chloride, chlorohydroxypropyltrimethylammonium chloride, and epoxypropyltrimethylammonium chloride, for example.

These quaternary amine catalysts have been used to catalyze hydrogen peroxide bleaching of wood pulp. Wood pulp cellulose pigments are not selectively resistant to hydrogen peroxide, and the unique action of catalyzed hydrogen peroxide on vat dyes would not be predicted or suggested by their action in wood pulp.

The concentration of the quaternary amines in the hydrogen peroxide solution should be from 0.1 to 1% and is preferably from 0.1 to 0.5%.

Following the hydrogen peroxide bleaching, rinse water is passed through the scrap laminae to remove residual bleach and catalyst.

After completion of the dye extraction, and if applied, the bleaching process, the scrap cake is removed from the basket and either subjected to centrifugal or hydraulic extraction to reduce the solvent content, broken up into individual scrap fragments, and the fragments are treated to remove residual solvent, that is, dried. A further aqueous solution or combination solution can be used to add various dyes, chemicals and reagents that may assist in optimization of the fabrics of this invention in subsequent processes or end use applications. The dried fragments are then passed through a conventional garnetting machine or similar device to separate the individual bleached cotton fibers. Subsequent processing will be determined by the desired end use of the fibers. For production of yarn, the fibers are preferably blended with longer virgin fibers, carded and spun into yarn by conventional procedures. For medical cotton applications, the fibers are processed by the traditional manufacturing procedure developed for each use.

The process of this invention is further shown by the following specific but non-limiting examples.

### EXAMPLE 1

### Dye Extraction

A forced circulation kier is loaded with 4000 lbs. of blue denim scrap and 28,000 lbs. of dimethyl formamide. Using a shell and tube steam-heated exchanger, the circulated bath is heated to a temperature of 130 deg. C. and the dimethyl formamide is circulated through the bed at a rate of 7500 gallons per minute.

After circulating the dimethyl formamide for 30 minutes, a 100 gallon/minute side stream of the solution, now containing extracted indigo dye, is cooled to 30° C. using a water-cooled shell and tube exchanger. The cooled solution is then passed through a filter press to recover crystallized dye. This extraction and filtration continues for the duration of the dimethyl formamide flow through the fabric bed. After filtration, 150 deg. C. nitrogen is passed through the filter cake in the filter press for a period of 30 minutes before dumping the dye into the dye recovery bin.

After a total circulation time of 3 hours, the dimethyl formamide flow through the fabric bed is stopped and the dimethyl formamide solution is emptied from the kier into a holding tank. A recirculation blower is then started to cause nitrogen at a pressure of 15 psig. to flow through the bed at a rate of 250 cubic feet per second. This gas stream is preheated in a shell and tube steam-heated exchanger to a temperature of 135° C. After passing through the bed, the same stream is passed through another shell and tube exchanger where the temperature is dropped to 30° C. and condensed dimethyl formamide is removed from the gas. All dimethyl formamide is returned to the clean dimethyl formamide holding tank for reuse.

After one hour, the blower is stopped and the kier is depressurized. The kier is filled with 50° C. water, circulated for 10 minutes, after which the bath is dropped. The rinse procedure is repeated once. At this point, the fabric is ready for bleaching. The extraction of dye from the fabric is uniform, and there are no spots in the fabric bed where more than a trace of dye remains on the fiber.

### EXAMPLE 2

### Desizing and Dye Removal

It is taught in U.S. Pat. No. 5,366,510 issued to Eric Wasinger and David Hall on Nov. 22, 1994, that solutions of reducing agents can be used to decolorize denim fabric dyed with indigo dye. Utilizing this art, the following procedure was used in a laboratory kier to uniformly remove indigo dye from denim scrap. A Thies laboratory kier was loaded with 8.14 kg. of sized dark blue (sulfur black bottom-dyed and indigo blue-dyed) denim cutting room scrap fabric pieces compressed to a density of 440 grams per liter. This device had a basket 230 mm in diameter and 445 mm long, having a volume of 18.5 liters. It required 57 kg. of water to fill the kier. Circulation was started through the fabric at a rate of 20 liters per minute per kilogram of fabric, and the temperature of the bath was set at 80° C.

Immediately, 740 ml. of 38° Baume′ sodium hydroxide solution, 170 g. of 95% sodium hydrosulfite powder, 57 g. of Setamol WS (dye dispersant manufactured by BASF), and 57 g. of Dekol Sn (dye dispersant and water sequestrant manufactured by BASF) were added to the kier. Circulation was maintained for 7 minutes and the bath was dropped. The kier was immediately refilled with 80° C. water and the same chemicals in the same quantity were again added. This was repeated four times at 7 minute intervals, then 80° C. rinse water was added to the kier, circulated for 7 minutes, and then the bath was dropped. This rinse procedure was repeated three times. At this point, the fabric was a very light shade of blue, indicating that most of the indigo dye had been extracted. Examination of the scrap pieces revealed that the extraction was very uniform and that there were no dark areas where dye had not been extracted.

The kier was then filled with 57 liters of 50° C. water, then 71 ml. of Delimol 9208 (dye dispersant and water sequestrant), 171 ml. of Delimol NSR (wetting and scouring agent manufactured by BASF), 285 ml. of 20% dihydroxypropyltrimethylammonium chloride solution, and 285 ml. of 38° Baume′ sodium hydroxide solution were added to the bath. The bath was circulated for 5 minutes at 50 deg. C. and 428 ml. of 35% hydrogen peroxide was added. The bath was heated at 5° C. per minute to 90° C., and then 2° C. per minute to 130° C. The bath was circulated for 5 minutes and then dropped. The kier was refilled with 80° C. water, circulated for 7 minutes, and then dropped. The kier was refilled with 70° C. water and 57 ml. of 60% acetic acid. This bath was circulated for 10 minutes and then dropped.

The basket was then transferred to a forced circulation pressure dryer and dried for 45 minutes. When removed from the basket, the fabric had a uniform CIE brightness of 85 and yielded fiber with good tensile strength.

### EXAMPLE 3

### Catalyzed Hydrogen Peroxide Bleaching

A Morton kier with a single-stock basket was loaded with 600 pounds of dark blue sized denim cutting room scrap which had been chopped into pieces no longer than 2.5 inches in any dimension. When the basket was loaded, the scrap material was compressed to an apparent density (dry basis) of 32 pounds per cubic foot. The kier was filled with approximately 400 gallons of water at 180° F. Circulation was started through the fabric at a rate of 1650 gallons per minute in a direction from the center standpipe outwards.

Bath components were added as follows: 60 pounds of 50% sodium hydroxide, 4.75 pounds of Amwet PTH wetter solution, and 8.34 pounds of dry sodium hydrosulfite. The kier was circulated for 15 minutes and then the bath was dropped.

The kier was again filled with 180° F. water, and bath components were added as follows: 60 pounds of 50% sodium hydroxide, 3.34 pounds of sodium hydrosulfite, and 2.36 pounds of Amwet PTH wetter solution. The kier was circulated for 15 minutes and then the bath was dropped. The same bath was made up and circulated for 15 minutes, then dropped twice more. At this point, the extracted fabric was inspected and found to be light blue, indicating that most of the indigo had been stripped from the cotton fiber.

The kier was then filled with 100° F. water, circulated for 10 minutes, after which the bath was dropped. The rinse procedure was repeated once and then the peroxide bleach bath was introduced. To prepare the bleach bath, the kier was first filled with 400 gallons of water at 100° F. Then 10.1 pounds of Amlight PBC bleach stabilizer, 6 pounds of prepared quaternary ammonium catalyst solution, and enough caustic soda to provide a bath pH of 10.7 and 34 pounds of 35% hydrogen peroxide were added.

The catalyst had been prepared as follows: First, 30 pounds of water was put into a 5-gallon pail, then 7.55 pounds of 65% 3-chloro-2-hydroxypropyltrimethylammoniumchloride (e.g. AmDye PTC from American Emulsions Inc.) was stirred into the water. After this was well mixed, 3 pounds of 50% caustic soda was mixed into the pail. Then, additional water was added to the pail until it contained exactly 5 gallons of liquid. The solution was mixed and allowed to sit for one hour.

Once the bleach bath components were added to the kier, the bath was heated at a rate of 15° F. per minute to a temperature of 230° F. The bath was circulated at temperature for 15 minutes, cooled to 180° F., and then dropped. The bleach bath was followed with two rinses: The first 10 minute rinse consisted of water and 6.67 pounds of glacial acetic acid at 140° F. The second rinse bath was dropped and the stock basket was removed for drying. An inspection of the fabric showed that it had been bleached to a brilliant white.

### EXAMPLE 4

### Bleaching with Sodium Hypochlorite

A Morton kier with a single stock basket is loaded with 600 pounds of dark blue sized denim cutting room scrap, which had been chopped into pieces no longer than 2.5 inches in any direction. When the basket is loaded, the scrap material is compressed to an apparent density (dry basis) of 32 pounds per cubic foot. The kier is filled with approximately 400 gallons of water at 180° F. Circulation is started through the fabric at a rate of 1650 gallons per minute in a direction from the center standpipe outwards.

Bath components are then added as follows: 60 pounds of 50% sodium hydroxide, 4.75 pounds of Amwet PTH wetter solution, and 8.34 pounds of dry sodium hydrosulfite. The kier is circulated for 15 minutes and then the bath is dropped.

The kier is again filled with 180° F. water and path components are added as follows: 60 pounds of 50% sodium hydroxide, 3.34 pounds of sodium hydrosulfite, and 2.36 pounds of Amwet PTH wetter solution. The kier is circulated for 15 minutes and then the bath is dropped. The same bath is made up, circulated for 15 minutes, and then dropped twice more. At this point, the extracted fabric is found to be light blue, indicating that most of the indigo has been stripped from the cotton fiber.

The kier is then filled with 100° F. water and circulated for 10 minutes, after which the bath is dropped. This rinse procedure is repeated once and then the hypochlorite bleach bath is introduced.

The kier is filled with 100° F. water and circulation is started. Bath components are added slowly as follows: 53.4 pounds of 10% sodium hypochlorite and 50% caustic soda as necessary to raise the pH to 10.5.

The temperature of the bleach bath is raised to 115° F. and circulated at 1650 gallons per minute for one hour. The bleach bath is then dropped and the kier is filled with 100° F. water and 2 pounds of sodiumthiosulfite. This bath is circulated for 5 minutes and dropped. The kier is then filled with water, circulated for 5 minutes and the bath is dropped. Examination of the fabric shows that it has a CIE brightness of 85 and a tensile strength loss of 10%.

Obviously, numerous modifications and variations of the present invention are possible in light of the above teachings. It is therefore to be understood that within the scope of the appended claims, the invention may be practiced otherwise than as specifically described herein.

It is claimed:

1. A process for liquid treatment of denim scrap comprising the steps of
a) placing sufficient denim scrap pieces on a support surface to form a thickness of flat, layered denim scrap comprising individual denim pieces with opposed surfaces having approximately parallel orientations, the thickness having a top surface;
b) applying a compression plate to said top surface to form the thickness of denim scrap into a compact cake; and
c) passing liquid through the interior of the compact cake in a direction parallel to the surfaces of the scrap, the liquid passing between opposed surfaces of the denim pieces.

2. A process according to claim 1 wherein the denim scrap pieces have a widest width of less than 4 inches.

3. A process according to claim 1 wherein the denim scrap pieces have a widest width of less than 2 inches and an average widest width of greater than 1 inch.

4. A process according to claim 1 wherein the liquid is solvent for the oxidized form of indigo dye, whereby indigo dye is removed from the denim scrap by said liquid.

5. A process according to claim 1 wherein liquid is an aqueous solution containing desizing agent, whereby size is removed from the denim scrap pieces.

6. A process according to claim 5 wherein the liquid is an aqueous solution containing reducing agent for indigo dye, whereby dye in the denim pieces is reduced to a soluble, reduced (leuco) form, dissolves in the solution, and both size and dye are removed from the denim scrap pieces simultaneously.

7. A process according to claim 1 wherein the liquid is an aqueous solution containing reducing agent for indigo dye, whereby dye in the denim pieces is reduced to a soluble, reduced form, dissolves in the solution, and is removed from the denim scrap pieces.

8. A process according to claim 1 wherein the liquid is an aqueous solution containing catalyzed hydrogen peroxide solution, the catalyst being a catalyzing amount of a transition metal cation or quaternary alkylamine salt which catalyzes oxidation reactions of hydrogen peroxide, whereby indigo dye in the denim scrap pieces is bleached or destroyed to remove color therefrom.

9. A process of claim 1 wherein the liquid is an aqueous solution containing an alkali metal hypochlorite.

10. A process for liquid treatment of denim scrap to remove dye from the scrap and decolorize the scrap comprising the steps of:
a) placing sufficient denim scrap pieces on a support surface to form a thickness
of flat, layered denim scrap comprising individual denim pieces with opposed surfaces, the thickness having a top surface;
b) applying a compression plate to said top surface to form the thickness of denim scrap into a compact cake;
c) passing a first aqueous solution through the interior of the compact cake in a direction parallel to the surfaces of the scrap, the first aqueous solution passing between opposed surfaces of the denim pieces, the first aqueous solution containing reducing agent for indigo dye, whereby dye in the denim pieces is reduced to a soluble, reduced form, dissolves in the solution, and is removed from the denim scrap pieces; and
d) passing a second aqueous solution through the interior of the compact cake in a direction parallel to the surfaces of the scrap, the second aqueous solution passing between opposed surfaces of the denim pieces, the second aqueous solution containing catalyzed hydrogen peroxide solution, the catalyst being an catalyzing amount of a transition metal cation or quaternaryalkylamine salt which catalyzes oxidation reactions of hydrogen peroxide, whereby indigo dye, other vat dyes, and sulfur dyes in the denim scrap pieces are bleached or destroyed to remove color therefrom.

11. A process according to claim 10 wherein the first aqueous solution contains desizing agent, whereby both size and dye are removed from the denim scrap pieces.

12. A process according to claim 10 wherein the denim scrap pieces have a widest width of less than 4 inches.

13. A process according to claim 12 wherein the denim scrap pieces have a widest width of less than 2 inches and an average widest width of greater than one inch.

14. The process of claim 10 in which a third aqueous solution is passed through the interior of the compact cake and consists of a combination of one or more dyes, chemicals or reagents used to assist in the optimization of the treated fabrics to be employed in subsequent processing or end use applications.

15. The process of claim 10 in which the third aqueous solution contains one or more of a surfactant, humectant, antibacterial agent, fiber lubricant, dyes or tints, optical brighteners, hand modifiers, or antistatic agents.

16. A process for liquid treatment of denim scrap to remove dye from the scrap and decolorize the scrap comprising the steps of:
a) placing sufficient denim scrap pieces on a support surface to form a thickness of flat, layered denim scrap comprising individual denim pieces with opposed surfaces, the thickness having a top surface;
b) applying a compression plate to said top surface to form the thickness of denim scrap into a compact cake;
c) passing a first aqueous solution through the interior of the compact cake in a direction parallel to the surfaces of the scrap, the first aqueous solution passing between opposed surfaces of the denim pieces, the first aqueous solution containing reducing agent for indigo dye, whereby dye in the denim pieces is reduced to a soluble, reduced form, dissolves in the solution, and is removed from the denim scrap pieces; and
d) passing a second aqueous solution through the interior of the compact cake in a direction parallel to the surfaces of the scrap, the second aqueous solution passing between opposed surfaces of the denim pieces, the second aqueous solution containing an alkali metal hypochlorite whereby the indigo vat dye, other vat dyes, or sulfur dyes are bleached or destroyed.
